(19) United States
(12) Patent Application Publication
(10) Pub. No.: US 2024/0177354 A1
(43) Pub. Date: May 30, 2024

(54) 3D OBJECT STREAMING METHOD, DEVICE, AND NON-TRANSITORY COMPUTER-READABLE RECORDING MEDIUM

(71) Applicant: Mawari Inc., Tokyo (JP)

(72) Inventors: Luis Oscar RAMIREZ SOLORZANO, Tokyo (JP); Aleksandr Mikhailovich BORISOV, Tyumen (RU)

(21) Appl. No.: 18/549,458

(22) PCT Filed: Mar. 4, 2022
(86) PCT No.: PCT/JP2022/009411

§ 371 Date: Sep. 7, 2023

(30) Foreign Application Priority Data
Mar. 9, 2021 (JP) 2021-037507

(51) Int. Cl. G06T 9/00; G06T 7/50; G06T 7/60; G06T 7/90; G06T 15/04; G06T 15/20; G06T 15/50; H04L 65/70

(52) U.S. Cl. CPC G06T 9/001; G06T 7/50; G06T 7/60; G06T 7/90; G06T 15/04; G06T 15/20; G06T 15/503; G06T 2207/10024; G06T 2207/10028; G06T 2210/08; H04L 65/70

(57) ABSTRACT

The present disclosure provides a method for sending at least one 3D object from a server to a client, the method including: extracting color information, alpha information and geometry information from the 3D object on the server; simplifying the geometry information; and encoding a stream including the color information, the alpha information and the simplified geometry information and sending the encoded stream from the server to the client.

### TECHNICAL FIELD

This disclosure relates to a method, an apparatus, and a program for streaming three-dimensional (3D) objects.

### BACKGROUND ART

Conventionally, techniques of transmitting a 3D image from a server to a client and displaying the image on a client have been available, but those techniques use, for example, a technique of converting a 3D image into a two-dimensional (2D) image on the server side (see, Patent Literature (hereinafter, abbreviated as PTL) 1).

### CITATION LIST

### Patent Literature

PTL 1

U.S. Patent Application Publication No. 2010/0134494

### SUMMARY OF INVENTION

### Technical Problem

A conventional problem to be solved is to reduce the bandwidth used for data transmission while maintaining the image quality in 3D image transmission.

### Solution to Problem

A method according to one aspect of the present disclosure is a method for sending at least one 3D object generated based on a position information of a client from a server to the client, comprising: extracting color information, alpha information and geometry information from the 3D object on the server: simplifying the geometry information: and encoding a stream including the color information, the alpha information and the simplified geometry information and sending the encoded stream from the server to the client.

A method according to one aspect of the present disclosure is a method for reproducing a 3D object generated based on a position information of a client on the client, the 3D object being present on a server, the method comprising: receiving from the server, an encoded stream including color information, alpha information and geometry information of the 3D object: decoding the encoded stream and extracting the color information, the alpha information and the geometry information from the decoded stream: reproducing a shape of the 3D object based on the geometry information: and projecting information on the reproduced shape of the 3D object to reconstruct the 3D object, the information resulting from combining the color information and the alpha information.

A server according to one aspect of the present disclosure includes at least one processor and a memory, the at least one processor executes instructions stored in the memory, to extract color information, alpha information and geometry information from a 3D object generated based on a position information of a client on the server: simplify the geometry information: and encode a stream including the color information, the color information, the alpha information and the simplified geometry information and send the encoded stream from the server to a client.

A client according to one aspect of the present disclosure includes at least one processor and a memory, the at least one processor executes instructions stored in the memory, to receive from a server, an encoded stream including color information, alpha information and geometry information of a 3D object generated on a position information of the client: decode the encoded stream and extract the color information, the alpha information and the geometry information from the decoded stream: reproduce a shape of the 3D object based on the geometry information: and project information on the reproduced shape of the 3D object to reconstruct the 3D object, the information resulting from combining the color information and the alpha information.

A computer program according to one aspect of the present disclosure includes: instructions by a processor to execute the method according to any one of the above mentioned methods.

These generic or specific aspects may be realized by a system, an apparatus, a method, an integrated circuit, a computer program, or a recording medium, or may be realized by any combinations of the system, the apparatus, the method, the integrated circuit, the computer program, and the recording medium.

### Advantageous Effects of Invention

The disclosure improves the display quality and responsiveness of 3D images on the client by reducing the amount of data per unit time transmitted from the server to the client by sending a container stream according to the disclosure instead of sending video data or pixels from the server to the client for displaying 3D images on the client.

Further advantages and effects in one embodiment of the disclosure will be apparent from the specification and drawings. While such advantages and/or effects are provided by the features described in the several embodiments and specification and drawings, respectively, all of them need not be provided to obtain one or more of the same features.

Although a description will be hereinafter given with transmission of 3D images (including moving images and/or still images) between a server and a client as an example for illustration purposes, the application of this disclosure is not limited to a client-server system and may be applied to the transmission from one computer to another computer or multiple computers.

### BRIEF DESCRIPTION OF DRAWINGS

FIG. 1 is a functional block diagram of a server and a client according to this disclosure;

FIG. 2 is a flowchart illustrating the processing on the server side of the data flow between the server and the client described in FIG. 1;

FIG. 3 is a flowchart illustrating the processing of data on the client side of the data flow between the server and the client described in FIG. 1;

FIG. 4 is a flowchart illustrating processing of a command on the client side of the data flow between the server and the client described in FIG. 1;

FIG. 5 is a diagram illustrating a data flow for displaying 3D scenes or 3D objects on the client side in a client-server system to which the disclosure is applied;

FIG. 6 is a diagram illustrating a process of encoding and decoding geometry information according to the disclosure;

FIG. 7 is a diagram illustrating a process of encoding and decoding color information/texture information according to the disclosure;

FIG. 8 is a diagram illustrating a data synchronization between geometry, color packets, metadata, and commands according to the disclosure;

FIG. 9 is a diagram showing a decal process according to this disclosure;

FIG. 10 is a schematic diagram showing an exemplary hardware configuration of a client according to the disclosure;

FIG. 11 is a schematic diagram showing an exemplary hardware configuration of a server according to the disclosure;

FIG. 12 is a schematic diagram illustrating an exemplary configuration of an information processing system according to the disclosure;

FIG. 13A is a schematic diagram showing the process flow of the server-side according to the disclosure;

FIG. 13B is a schematic diagram showing the process flow of the server-side according to the disclosure;

FIG. 14 is a schematic diagram showing a flow of processing of the client-side according to the disclosure;

FIG. 15 is a diagram showing the arrangement of the cameras used in the disclosure; and

FIG. 16 is a diagram showing a pixel configuration in an ARGB system used in the disclosure.

FIG. 17 is a diagram showing change of position information when the client moved.

FIG. 18 is a diagram showing motion prediction and error detection in the image view.

### DESCRIPTION OF EMBODIMENTS

### 1. 3D Streaming System Architecture

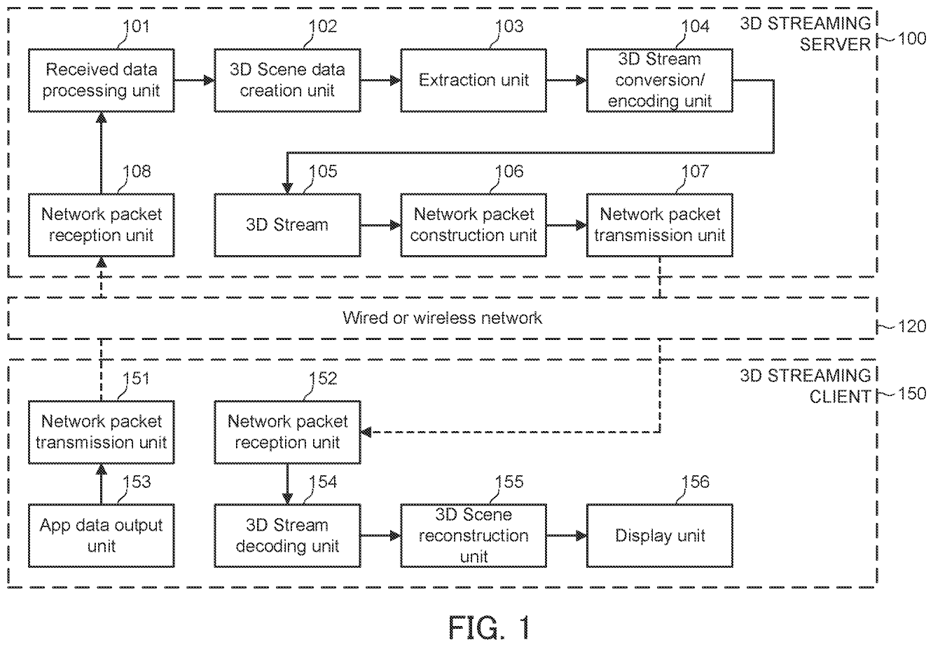

FIG. 1 is a functional block diagram of a server and a client according to the disclosure. 3D streaming server 100 includes a functional configuration within a three-dimensional (3D) streaming server, and 3D streaming client 150 includes a functional configuration within a streaming client. Network 120 represents a wired or wireless network between server 100 and client 150.

One system subject to the disclosure generates 3D images on the server side, and reconstructs 3D images on the basis of the features of 3D images received from the server and displays the 3D images on the client side. As the client device, any device having a display function and a communication function, such as a smartphone, a cell phone, a tablet, a laptop computer, a smart glass or smart glasses, a head-mounted display, a headset, or the like, is suitable for the disclosure. Herein the amount of characteristic (may be referred to as feature quantity, feature value, feature amount, or feature) include color information, alpha information, or geometry information of 3D images.

### 1.2 3D Streaming Server-Side Processing

The upper half of FIG. 1 is a functional block diagram illustrating a process in 3D streaming server 100. Network packet reception unit 108 receives packets containing instructions and/or data from client 150 via wired or wireless network 120. Network packet reception unit 108 extracts the instructions and/or data received from the client from the packet and transmits the extracted data to received data processing unit 101, which processes the instructions and/or data from the client. Received data processing unit 101, which receives the extracted instructions and/or data from the clients, further extracts the required instructions and/or data from the received data and sends them to 3D scene data creation unit 102. Then, 3D scene data creation unit 102 processes and modifies the data of 3D scene (or 3D object) corresponding to the request managed by the server from the client in accordance with the request sent from client 150. Extraction unit 103, which receives the instructions and/or data from 3D scene data creation unit 102, then extracts the required data from the updated 3D scene data according to the instructions from the clients and sends them to 3D stream conversion/encoding unit 104. 3D stream conversion/encoding unit 104 converts the data received from extraction unit 103 into a 3D stream and encodes the converted data to generate 3D stream 105. 3D stream 105 is then sent to network packet construction unit 106 and a network packet is generated by network packet construction unit 106. The network packets are transmitted to network packet transmission unit 107. Network packet transmission unit 107 transmits the received network packet to one or more clients 150 via wired or wireless network 120.

### 1.3 3D Streaming Client-Side Processing

The lower half of FIG. 1 is a functional diagram illustrating the process in 3D streaming client 150. Network packet reception unit 152, which has received the packet from server 100 via wired or wireless network 120, extracts the encoded 3D stream from the packet and sends it to 3D stream decoding unit 154. 3D stream decoding unit 154 that received the encoded 3D stream decodes 3D stream and sends the decoded 3D stream to 3D scene reconstruction unit 155. Upon receiving the decoded 3D stream, scene reconstruction unit 155 reconstructs 3D scene (or 3D object) from 3D stream received from server 100 and sends the reconstructed 3D scene to display unit 156. Display unit 156 displays and presents the reconstructed 3D scenes to a user.

On the other hand, a 3D display (update) request from 3D streaming client 150 is sent from application data output unit 153 to network packet transmission unit 151. As 3D display (update) request data generated by application data output unit 153, for example, user input or camera/device position change or a command for requesting updating the display may be considered. Upon receiving 3D display request, network packet transmission unit 151 sends, via wired or wireless network 120, 3D streaming server 100 3D display (update) request that has been processed as required, such as encoding and packetization.

Network packet construction unit 106 and network packet transmission unit 107 included in server 100 described above, network packet reception unit 152 and network packet transmission unit 151 included in client 150 described above, may, for example, be modified as required based on the corresponding transmission and reception modules of existing open source software, or may be created exclusively from scratch.

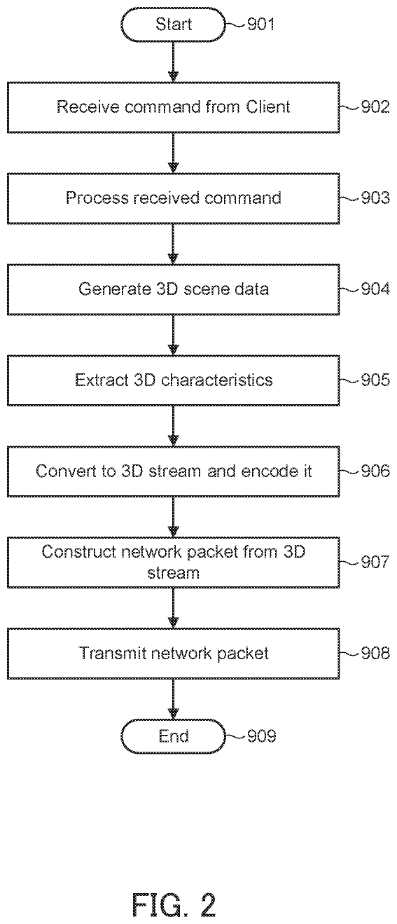

FIG. 2 is a flowchart illustrating processing on the server side of the data flow between the server and the client described in FIG. 1. In step 901, the processing is started. First, network packet reception unit 108 described in FIG. 1 receives a packet including a rewrite command of 3D scene from the client in step 902. Next, reception data processing unit 101 described in FIG. 1 processes the received command, and outputs the result in step 903. Next, 3D scene data creation unit 102 described in FIG. 1 generates 3D scene data according to the received command or the like in step 904. Next, extraction unit 103 of FIG. 1 extracts feature amount of 3D scene in step 905. Herein the feature amount refers to data such as geometry, color, metadata, sound, and commands included in the container stream to be described later. Next, 3D stream conversion/encoding unit 104 of FIG. 1 converts the data including 3D feature amount into a 3D stream and encodes the converted data in step 906. Next, network packet construction unit 106 of FIG. 1 constructs a network packet from the 3D stream in step 907. Next, network packet transmission unit 107 of FIG. 1 transmits a network packet in step 908. This terminates a series of server-side data transmission processes in step 909.

In FIG. 2, as an example, the processing of steps 902 to 903 and the processing of steps 904 to 908 are sequentially executed, but the processing of steps 902 to 903 and the processing of steps 904 to 908 may be executed in parallel or may be started from the processing of step 904. Wherein the received position information is described and it can be used on the server to update the geometry information of the mesh. Then the prediction at this stage for the next frame and update of the motion model may be implemented. The motion/position information may be received from the client. The pose information can be used to build up a history of poses, and thus to predict the motion of the vertex data in the next frame. This updated pose may be compared with the next client supplied data set to validate the prediction and, where necessary, correct the estimated motion model.

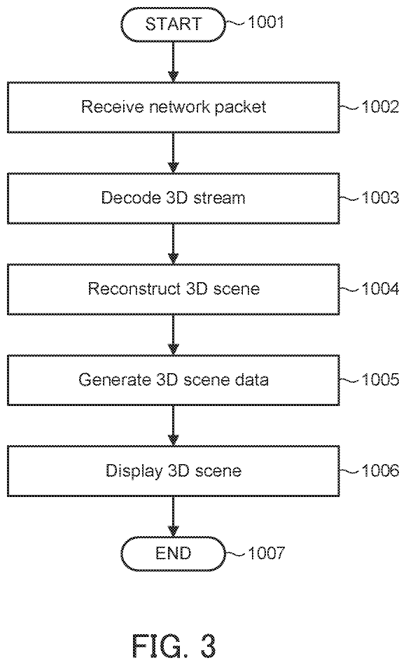

FIG. 3 is a flowchart illustrating processing of data on the client side among the data flows between the server and the client described in FIG. 1. In step 1001, the processing is started. First, network packet reception unit 152 described in FIG. 1 receives a packet sent from server 100 in step 1002. Next, 3D stream decoding unit 154 described in FIG. 1 decodes the received packets and extracts the feature amount of 3D scenes. Next, 3D scene reconstruction unit 155 described in FIG. 1 reconstructs 3D scene on the clients using feature amount of 3D scene or the like in step 1004, and generates 3D scene data in step 1005. Next, display unit 156 described in FIG. 1 displays the reconstructed 3D scenes and presents them to the user in step 1006. This terminates the client-side data processing in step 1007.

In FIG. 3, as an example, the processing of steps 1002 to 1004 and the processing of steps 1005 to 1006 are sequentially executed, but the processing of steps 1002 to 1004 and the processing of steps 1005 to 1006 may be executed in parallel or may be started from the processing of step 1005.

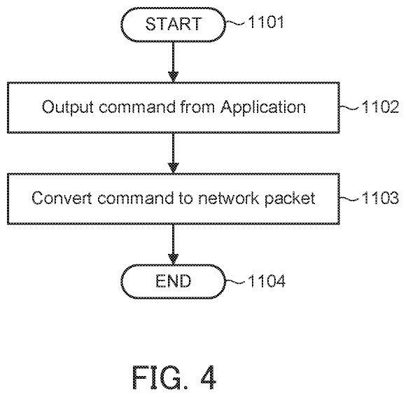

FIG. 4 is a flowchart illustrating processing of a command on the client side among the data flows between the server and the client described in FIG. 1. In step 1101, the processing is started. Application data output unit 153 described in FIG. 1 outputs commands for rewriting 3D scenes from an image-processing application or the like in step 1102. Network packet transmission unit 151 described in FIG. 1 receives a command or the like from application data output unit 153, converts it into a packet, and transmits the converted packet to wired or wireless network 120 in step 1103. This terminates the client-side data processing in step 1104.

In FIG. 4, as an example, the processing of step 1102 and the processing of step 1103 are sequentially executed, but the processing of step 1102 and the processing of step 1103 may be executed in parallel.

### 2. 3D Stream Format According to the Disclosure

The format of 3D streams according to the disclosure is mainly characterized by the following. It is significant to realize these by using limited network bandwidth without degrading 3D images displayed on the client-side.

### 1) 3D Streaming is Generated on the Server-Side

When generating 3D streams on the server side, an available engine such as UE4 or Unity is used. Herein UE is a game engine, named “Unreal Engine” developed by Epic Games Inc., and UR5 was announced in May 2020.

### 2) Efficient Transmission Over the Network is Supported

Therefore, the amount of data transferred from the server to the client is smaller than that of the conventional method. To accomplish this, a container stream is used for the present disclosure.

### 3) Operable With a Variety of Devices

The target devices can be, for example, any devices available for a Unity (Android, Windows, iOS), a WebGL, UE4, or UE5 (Android, IOS, Windows).

### 4) Relatively Light for Modern AR (Augmented Reality) Devices

That is, compared with the conventional method, the processing load on the client side is smaller. This is due to the use of the container stream according to the present disclosure.

### 5) Interactions (i.e., Two-Way Communication) is Supported

That is, the streaming is interactive. This is because commands can be sent and received between the client and the server for both directions.

In order to embody the features described above, the disclosure has developed its own container stream as a 3D stream for transmission between the server and the clients. This proprietary container stream includes some of the following geometry, color, metadata, sound, and command. The stream may further include position information of the server and/or the client.

1) Geometry: A simplified 3D date of the outline of a streamed object of a 3D scene on a server. The geometry data is, for example, an array of vertices of a polygon used to represent the shape of the object.

2) Color: Color data of an object captured by a camera at a specific position.

3) Metadata: Metadata is data describing 3D scenes, environments, individual objects, data in streams, etc.

4) Sound: Sound is sound (audio) data that occurs in a 3D scene on the server or client side. Sounds can communicate bidirectionally between the server and the client.

5) Command: Command is instructions include server-side or client-side 3D scenes, system events, status messages, camera, user inputs, and client application events. Command can communicate bidirectionally between the server and the client.

In conventional systems, instead of the above-described container stream according to this disclosure, video-data itself or pixel-data of every frame is sent. Herein a container stream refers to a chunk of data transferred between a server and a client, and is also referred to as a data stream. The container stream is transmitted over the network as a packet stream.

The conventional video data itself or pixel data of each frame, even if it is compressed, has a very large capacity to be transferred per second, and if the bandwidth of the network between the server and the client is not large, there are problems like transmission is delayed, a latency occurs, and 3D images on the client side cannot be reproduced smoothly. On the other hand, in the system according to the present disclosure, the data container used for transmission between the server and the client has a much smaller data size than that in the conventional system, so that the number of frames per unit time can be secured at a minimum without worrying about the bandwidth of the network between the server and the client, so that smooth 3D images can be reproduced on the client side.

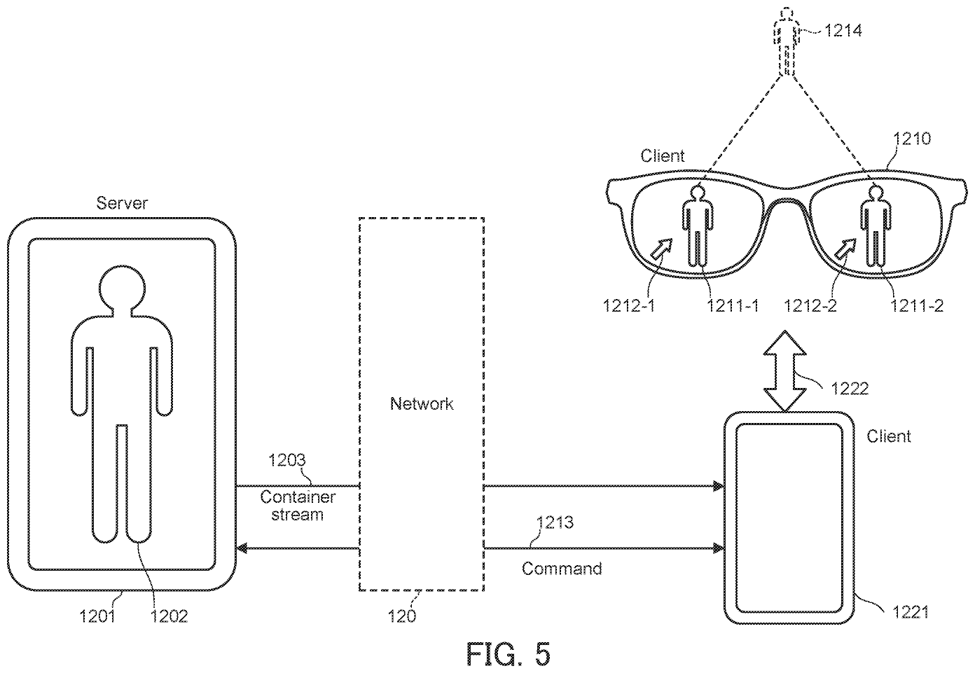

FIG. 5 is a diagram illustrating a data flow for displaying a 3D scene or a 3D object on the client side in a client-server system to which this disclosure is applied. On the client side, terminal device 1221 such as a smartphone is described, and terminal device 1221 and smart glasses 1210 are connected via wireless communication or wired communication 1222 by a wireless LAN or Bluetooth® or the like. Smart glasses 1210 represents a view seen from the near side by the user. Person 1211-1 and cursor 1212-1 are projected on the left eye of the smart glasses of the client, and person 1211-2 and cursor 1212-2 are projected on the right eye of the smart glasses. To the user of the smart glasses, images of the right eye and the left eye overlap, and stereoscopic person 1214 appears slightly apart from the user. The user of the client-side smart glasses 1210 may use cursor 1212 or other input means to move, rotate, scale, change color/texture, sound, etc. with respect to person 1214 displayed in client-side smart glasses 1210. When the operation is performed on an object (or scene) on such a client, command (or sound) 1213 or the like is transmitted from the client to the server via network 120. In this example, the object is a person, but the object can be anything other than a person, such as a building, a car, an animal, or a still life, and a scene can contain two or more objects.

The server that receives a command or the like from the client via network 120 performs an operation according to the received command or the like on the image of the corresponding person 1202 on virtual screen 1201 in the application in the server. Herein the server does not normally need to have a display device, but handles virtual images in a virtual space. Next, the server generates 3D scene data (or 3D object data) after performing an operation such as this command, and transmits the extracted feature amount as container stream 1203 to the client through network 120. The client received container stream 1203 sent from the server rewrites and redisplays the data of the corresponding person 1214 in the client's virtual screen in accordance with the geometry, color/texture, metadata, sound, and commands contained in container stream 1203.

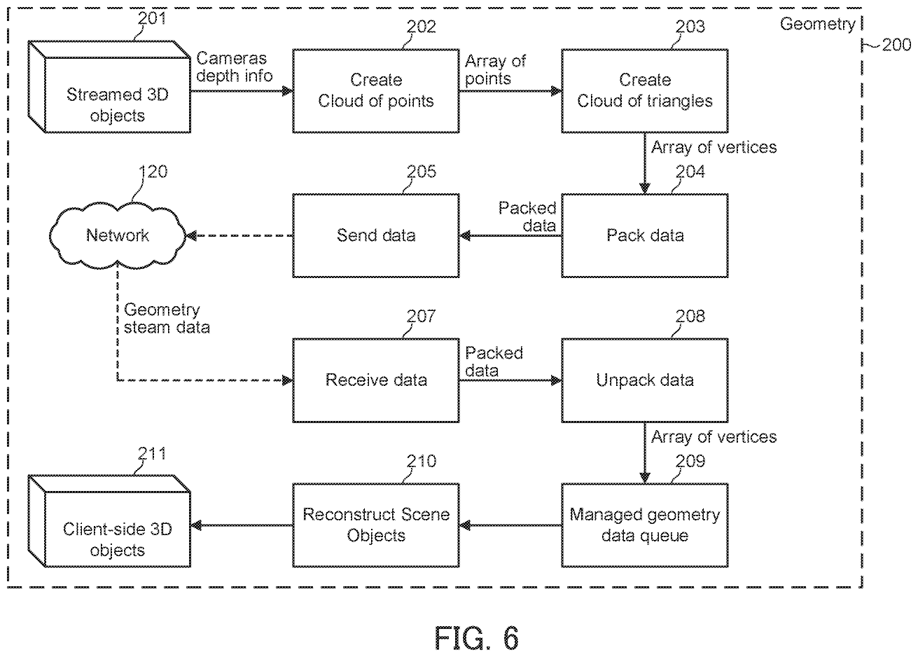

Referring now to FIGS. 6-8, it will be described how the “geometry” data and “color” data contained in the container stream described above are processed.

### 3. Geometry Encoding and Decoding Process

FIG. 6 is a diagram showing processes of encoding and decoding of geometry data according to the disclosure. In FIG. 6, the processing of steps 201 to 205 is performed by the server, and the processing of steps 207 to 211 is performed by the client.

The processes shown in FIGS. 6, and 7 and 8 to be described are executed by a processor such as a CPU and/or a GPU using related programs.

The system subject to this disclosure may include only one of the CPU or GPU, but the CPU and GPU are collectively referred to as the CPU in the following sections for simplicity of explanation.

### 3.1 Server-Side Processing

Now assume that there is a scene with an object. Each object has been captured with one or more depth cameras. Herein a depth camera refers to a camera with a built-in depth sensor that acquires depth information. Using the depth camera, depth information can be added to the two-dimensional (2D) images acquired by a normal camera to acquire three-dimensional information of 3D. Herein for example, six depth cameras are used to acquire the complete geometry data of the scene. The configuration of the camera during shooting will be described later.

Streamed 3D objects are generated from images captured at the server, and depth data of the cameras are outputted in step 201. Next, the depth information from the camera is processed to generate a point cloud, and an array of points is outputted in step 202. This point cloud is converted into triangles representing the actual geometry of the object (an array of triangular vertices) and a group of triangles is generated by the server in step 203. Herein as an example, a triangle is used as a figure representing a geometry, but a polygon other than a triangle may be used.

The geometry data is then added to the stream using the data in the array of each vertex of the group of triangles and then the stream is packed in step 204.

The server transmits the container stream containing packed geometry data over network 120 in step 205.

### 3.2 Processing on the Client Side

The client receives compressed data transmitted from the server, or a container stream containing geometry data, from the server via network 120 in step 207. The client decompresses the received compressed data and extracts an array of vertices in step 208.

The client places the array of vertices of the decompressed data into a managed geometry data queue to correctly align the order of the sequence of frames broken while being transferred over the network in step 209. The client reconstructs the objects in the scene based on the correctly aligned frame sequence in step 210. The client displays the reconstructed client-side 3D on a display in step 211.

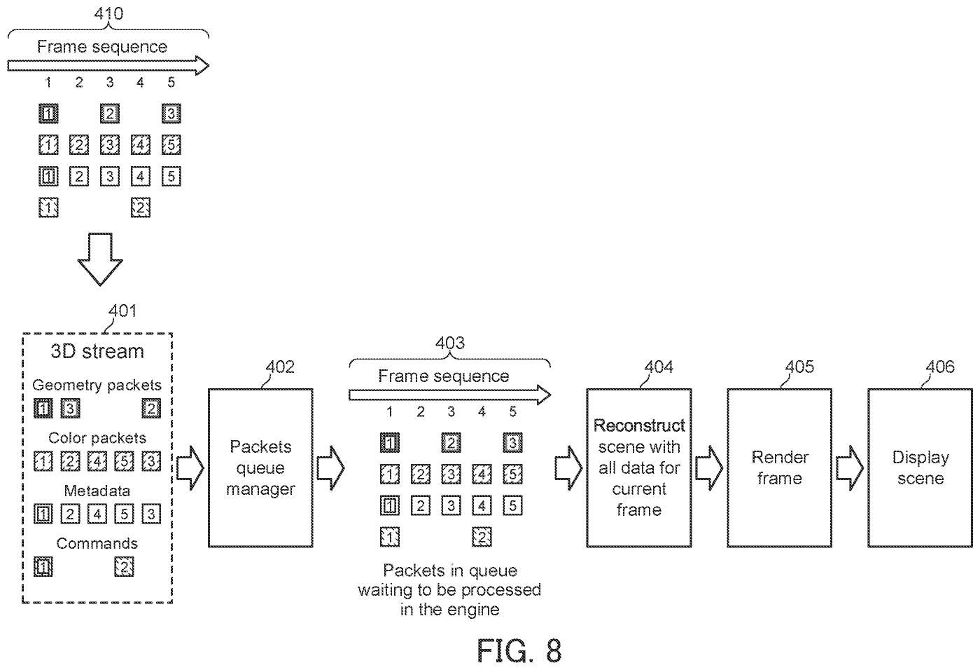

Geometry data is stored in a managed geometry data queue and synchronization with other data received in the stream in step 209. This synchronization will be described later with reference to FIG. 8.

The clients to which this disclosure is applied generate meshes based on the received arrays of vertices. In other words, since only arrays of vertices are transmitted as geometry data from the server to the client, the amount of data per second in the array of vertices is typically much less than that of video and frame data. On the other hand, another conventional option is to apply a large amount of triangles to a given mesh of data, and this method requires a large amount of processing on the client side, which has been problematic.

Since the server to which this disclosure is applied sends only the data of the part of the scene (usually containing one or more objects) that needs to be changed (for example, a particular object) to the client, and does not send the data of the part of the scene that has not being changed to the client, this point can also reduce the amount of data transmitted from the server to the client due to the scene change.

Systems and methods employing this disclosure assume that arrays of vertices of polygon meshes are transmitted from servers to clients. Although a triangular polygon is assumed as the polygon, the shape of the polygon is not limited to a triangle and may be a square or another shape.

### 4. Color/Texture Encoding and Decoding Processing

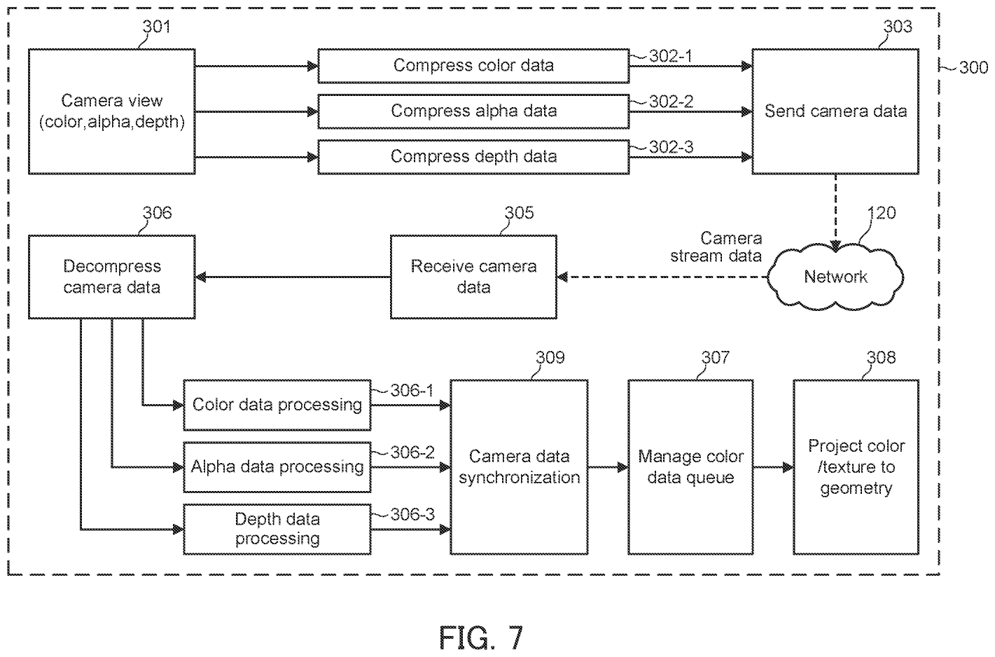

FIG. 7 is a diagram showing processes of encoding and decoding of color information/texture information according to the disclosure. In FIG. 7, the processing of steps 301 to 303 is performed by the server, and the processing of steps 305 to 308 is performed by the client.

### 4.1 Color Server-Side Processing

Suppose there is a scene with an object. Using the view from the camera, the server extracts the color data, alpha data, and depth data of the scene in step 301. Herein the alpha data (or alpha value) is a numerical value indicating additional information provided for each pixel separately from the color information. Alpha data is often used particularly as transparency. The set of alpha data is also called an alpha channel.

The server then adds each of the color data, alpha data, and depth data to the stream and compresses them in steps 302-1, 302-2, and 302-3. The server sends the compressed camera data as part of the container stream to the client via network 120 in step 303.

### 4.2 Client-Side Processing of Colors

The client receives a container stream containing the compressed camera data stream via network 120 in step 305. The client decompresses the received camera data, as well as preparing a set of frames in step 306. Next, the client processes color data, alpha data, and depth data of the video stream from the decompressed camera data respectively in steps 306-1, 306-2, and 306-3. Herein these raw feature amount data are prepared and queued for application to the reconstructed 3D scenes. The color data is used to wrap meshes of the reconstructed 3D scenes with the texture.

Additional detail information with the depth and alpha data are also used. The client then synchronizes the color data, alpha data, and depth data of the video stream in step 309. The client stores the synchronized color data, alpha data, and depth data in a queue and manages the color data queue in step 307. The client then projects the color/texture information to the geometry in step 308.

FIG. 8 is a diagram illustrating a data synchronization between geometry packets, color packets, metadata, and commands according to the disclosure.

To make the data available on the client side, the data must be managed in a way that provides the correct content of the data in the stream while playing back 3D images received on the client side. Since data packets going through the network are not necessarily transmitted in a reliable method, and packet delays and/or packet order changes may occur. Thus, while the client receives the container stream of data, the client's system must consider how to manage synchronization of the data. The basic scheme for synchronizing the geometry, color, meta-data, and commands according to the disclosure are as follows. This scheme may be standard for data formats created for network applications and streams.

Referring to FIG. 8, 3D stream 410 transmitted from the server includes geometry packets, color packets, metadata, and commands. The geometry packets, color packets, metadata, and commands contained in 3D stream are synchronized to each other as shown in frame sequence 410 at the time 3D stream is created on the server.

In this frame sequence 410, time flows from left to right. However, when the frame sequence 410 transmitted from the server is received by the client, there may be cases where mutual synchronization cannot be obtained while passing through the network or random delays may occur, as indicated in 3D stream 401 received on the client side. That is, within 3D stream 401 received by the client, it can be seen that the geometry packets, color packets, metadata, and commands may be different in order or location in the sequence from 3D stream 410 when created by the client.

3D stream 401 received at the client is processed by packet queue manager 402 back to its original synchronization to generate frame sequence 403. In frame sequence 403 in which synchronization is restored by packet queue manager 402 and the different delays are eliminated from each other, the geometry packets 1, 2, and 3 are in the correct order and arrangement, the color packets 1, 2, 3, 4, and 5 are in the correct order and arrangement, the metadata 1, 2, 3, 4, and 5 are in the correct order and arrangement, and the commands 1 and 2 are in the correct order and arrangement. That is, frame sequence 403 after alignment in the client is the same order as frame sequence 410 created in the server.

The scene is then reconstructed using the data for the synchronized present frame in step 404. The reconstructed frames are then rendered in step 405 and the client displays the scene on the display in step 406.

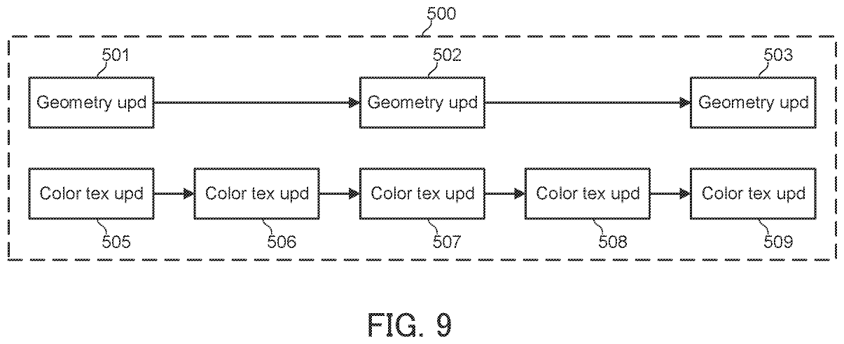

FIG. 9 shows an example of a sequence update flow 500. In FIG. 9, the time flows from left to right. Referring to FIG. 9, first, the geometry is updated in step 501. Herein the color/texture is updated in synchronization with it (i.e. with the lateral position coinciding) in step 505. Next, the color/texture is updated in step 506, but the geometry is not updated (e.g., if the color has changed but there is no motion). Next, the geometry is updated in step 502 and the color/texture is updated in synchronization thereto in step 507. Next, the color/texture is updated in step 508, but the geometry is not updated. The geometry is then updated 503 and the color/texture is updated in synchronization thereto in step 509.

As can be seen from FIG. 9, the geometry need not be updated each time the color/texture is updated, and conversely, the color/texture need not be updated each time the geometry is updated. Geometry updates and color/texture updates may be synchronized. Also, the color/texture update needs not necessarily to be a color and texture update, but may be either a color or texture update. In this figure, color/texture updates are described twice, while geometry updates are described once, but this is an example and may be other frequencies.

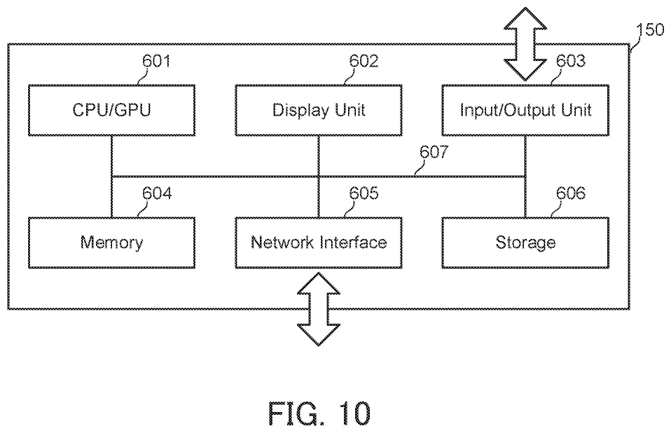

FIG. 10 is a schematic diagram showing an exemplary hardware configuration of the client according to this disclosure. Client 150 may be a terminal such as a smartphone or a mobile phone. Client 150 typically comprises CPU/GPU601, display unit 602, input/output unit 603, memory 604, network interface 605, and storage unit 606, which are communicatively coupled to each other by bus 607.

CPU/GPU601 may be a single CPU or a single GPU, or may consist of one or more components that are adapted to operate in conjunction with the CPU and the GPU. Display unit 602 is generally a device for displaying an image in color, and displays a 3D image according to the disclosure and presents it to the user. Referring to FIG. 5, as described above, the client may be a combination of a client terminal and a smart glasses, in which case the smart glasses has the function of display unit 602.

Input/output unit 603 is a device for interacting with the outside, such as a user, and may be connected to a keyboard, a speaker, buttons, or a touch panel inside or outside client 150. Memory 604 is a volatile memory for storing software and data required for operation of CPU/GPU601. Network interface 605 has a function for client 150 to connect to and communicate with an external network. Storage unit 606 is a non-volatile memory for storing software, firmware, data, and the like required by client 150.

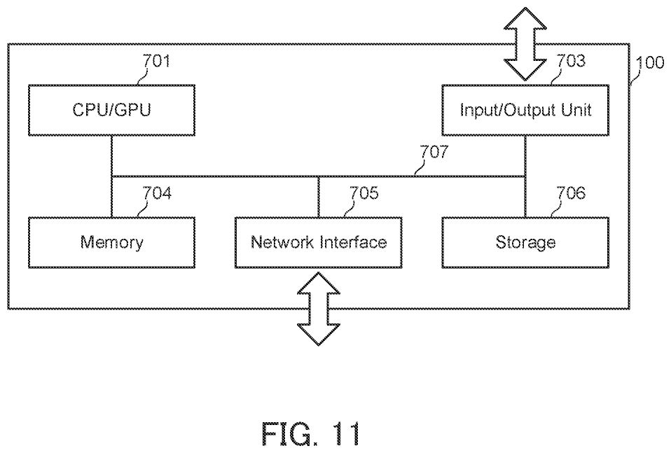

FIG. 11 is a schematic diagram illustrating an example of a hardware configuration of a server according to the disclosure. Server 100 typically has a higher performance CPU than the client, a higher communication speed, and a higher capacity storage device. Server 100 typically comprises CPU/GPU701, input/output unit 703, memory 704, network interface 705, and storage unit 706, which are communicatively coupled to each other by bus 707.

CPU/GPU701 may be a single CPU or a single GPU, or may consist of one or more components that are adapted to operate in conjunction with the CPU and the GPU. The client device described in FIG. 10 includes display unit 602, but in the case of a server, the display unit is not required. Input/output unit 703 is a device for interacting with a user or the like, and may be connected to a keyboard, a speaker, buttons, or a touch panel. Memory 704 is a volatile memory for storing software and data required for operation of CPU/GPU 701. Network interface 705 provides the capability for server 100 to connect and communicate with an external network. Storage device 706 is a non-volatile storage device for storing software, firmware, data, and the like required by server 100.

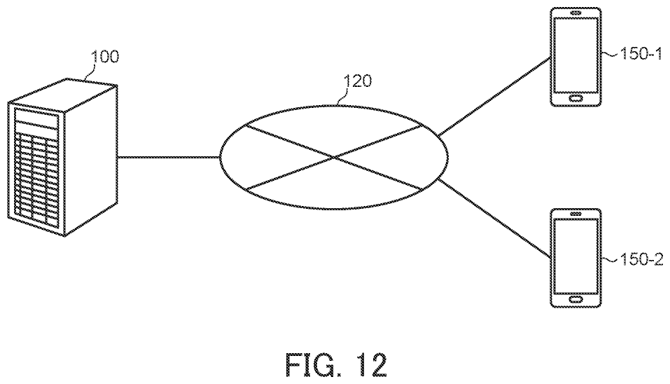

FIG. 12 is a schematic diagram showing an exemplary configuration of an information processing system according to this disclosure. Server 100, client 150-1, and client 150-2 are communicatively coupled to each other by network 120.

Server 100 is, for example, a computer device such as a server that operates in response to an image display request from client 150-1 and client 150-2 to generate and transmit information related to the image for display on client 150-1 and client 150-2. In this example, two clients are described, but at least one client can be used.

Networks 120 may be a wired or wireless LAN (Local Area Network), and clients 150-1 and 150-2 may be smartphones, mobile phones, slate PCs, gaming terminals, or the like.

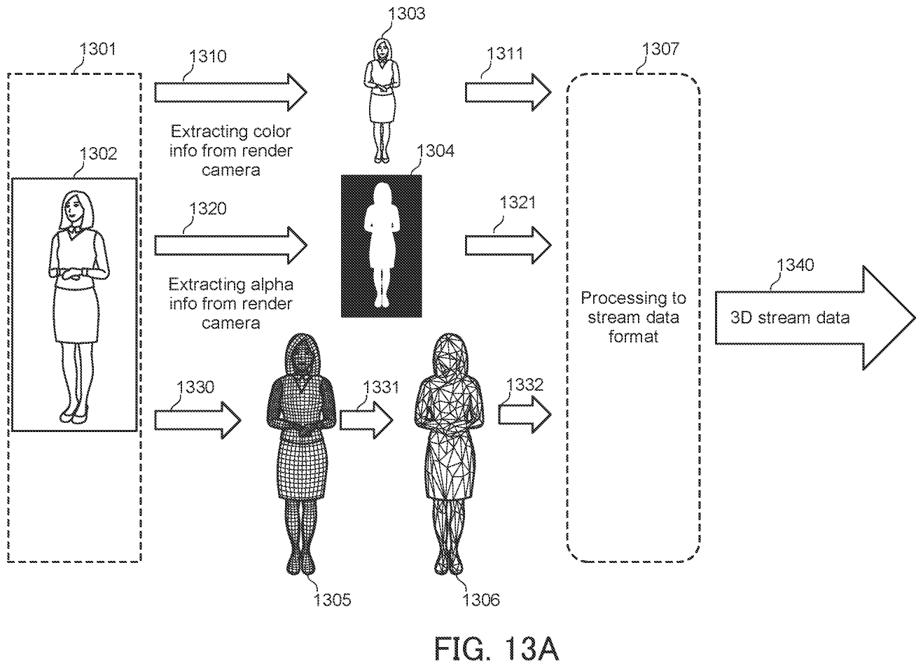

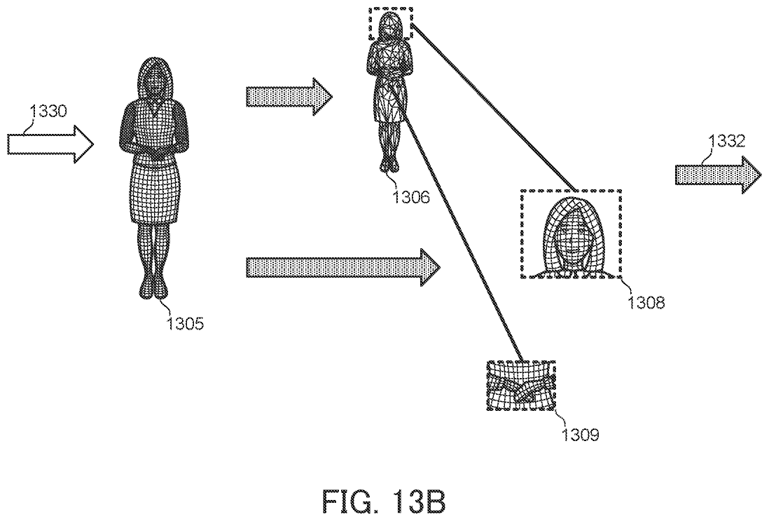

FIG. 13A is a schematic diagram showing the flow of the server-side process according to the disclosure. An RGB camera is used to extract color information 1303 from object 1302 in scene 1301 on the server side in step 1310. Alpha information 1304 is extracted from object 1302 in server-side scene 1301 using RGB camera 1320. From object 1320 in scene 1301 of the server side, the information of point group 1305 is extracted using depth camera 1330. Next, the information of point cloud 1305 is simplified to obtain geometry information 1306 in step 1331.

Next, resulting color information 1303, alpha information 1304, and geometry information 1306 are processed into stream data format 1307 and transmitted to the client over the network as a container stream of 3D stream in step 1340.

FIG. 13B is a schematic diagram showing the process flow of the server-side according to the disclosure. FIG. 13B shows the concept of reducing the spatial frequency of the mesh representing a low frequency component. The coarse mesh (1306) may be associated with a high frequency component (1308, 1309) that can represent the detail of the surface. The z-buffer can be used to select the faces to be rendered in order to bypass the need for the camera. Z-buffer can also be used to extract the alpha (clear) channel, since the surface to be rendered is effectively at infinity. The high resolution mesh (point cloud) can be decomposed into low resolution mesh along with high frequency components. Note that the smoothed low resolution mesh (1306) can be obtained by removing the high frequency components from the high resolution mesh (1305).

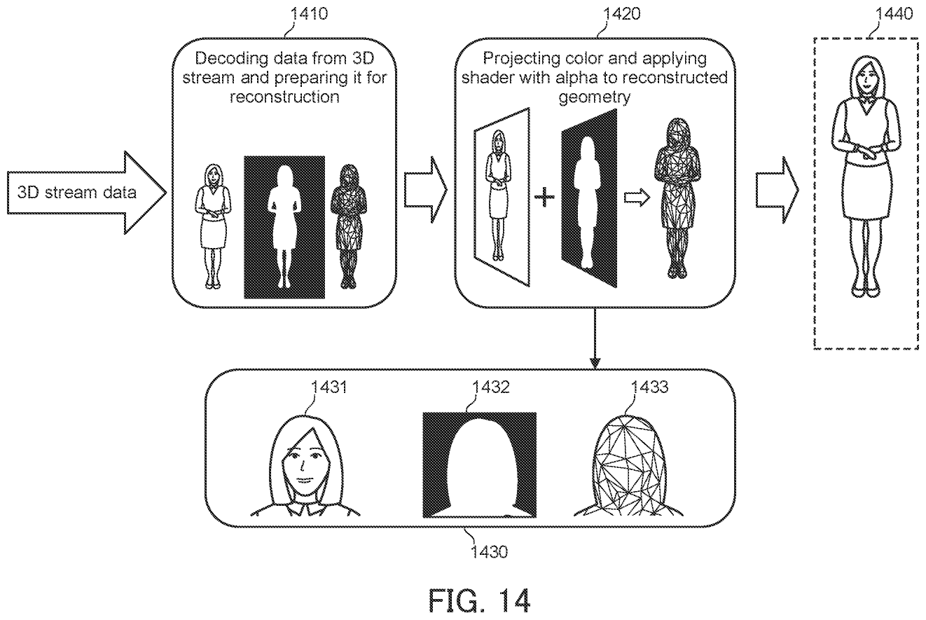

FIG. 14 is a schematic diagram showing the flow of a client-side process according to the disclosure. FIG. 14 relates to a decal process according to this disclosure. Herein decal is the process of pasting a texture or a material on an object. Herein texture refers to data used to express texture, patterns, irregularities (asperities), etc. of 3D (three -dimensional) CG model. The material refers to the material of the object, and in 3DCG refers to, for example, the optical characteristics and the material feeling of the object.

The reason why this disclosure's decal methodology is lighter for processor than traditional UV-mapping is described below. Currently, there are several ways to set the color for the mesh. Herein the UV is a coordinate system used to specify the position, orientation, size, and the like to be pasted when the textures are mapped to 3DCG models. In a two-dimensional orthogonal coordinate system, the horizontal axis is U and the vertical axis is V. Texture mapping using a UV coordinate system is called UV mapping.

### 5.1 How to Set Color for Each Vertex (Conventional Method 1)

Store color values at the vertices for all triangles in the target cloud. However, lower vertex density results in lower resolution texturing, which degrades the user experience. Conversely, a high vertex density is the same as sending colors to all the pixels on the screen, increasing the amount of data transferred from the server to the client. On the other hand, this can be used as an additional/basic coloring step.

### 5.2 How to Set the Correct Texture for the UV of the Mesh (Conventional Method 2)

In order to set the correct texture by UV mapping, it is necessary to generate textures of a group of triangles. It then needs to create a UV map for the current mesh and add it to the stream. The original texture of the model is substantially unusable because it does not contain information such as lightning of scenes, and a large amount of texture is required for a high-quality and detailed 3D model. Another reason why this method is not employed is that the original texture operates on UVs created with 3D modeling rendered on the servers. Generally, a group of triangles is used to project a coloring texture from different views and to store and transmit the received UV texture. In addition, the amount of data transmitted and received between the server and the client increases because the geometry and topology of the mesh must be updated at the same frequency as the UV texture.

5.3 Projecting a Texture on a Mesh (Decal) Method (This disclosure Method)

Color/texture from a specific location in the stream is sent from the server to the client along with meta information about that location. The client projects this texture from the specified position onto the mesh. In this case, no UV map is required. In this method, the streamed side, i.e., the client side, is not loaded with UV generation. This decal approach can provide room for optimization of the data flow (e.g., updating geometry and color can be done continuously at different frequencies).

The processing on the client side shown in FIG. 14 basically performs processing opposite to the processing on the server side shown in FIG. 13. First, the client receives a container stream, which is a 3D stream sent by the server over the network. Then, the data is decoded from the received 3D stream and the color information, alpha information, and geometry information are restored to reconstruct the object in step 1410.

Next, first, color information 1431 and alpha information 1432 are combined to generate texture data as a result. The texture data is then applied to geometry data 1433 in step 1420. This allows the objects on the server to be reconfigured on the client in step 1440. If there are multiple objects in the scene on the server side, such processing is applied for each object.

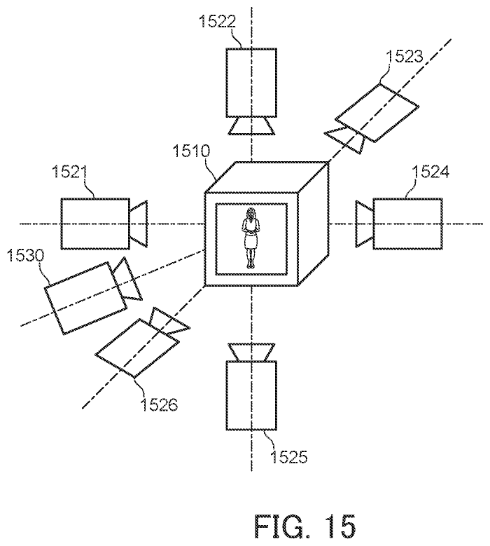

FIG. 15 shows the arrangement of the cameras used in this disclosure. One or more depth cameras can be used to obtain geometry information for objects in scene of interest 1510. The depth camera captures depth maps every frame, and these depth maps are then processed into point clouds. The point cloud is then divided into predetermined triangular meshes for simplicity. By changing the resolution of the depth camera, it is possible to control the degree of detail (level of fineness, or granularity) of the mesh divided into triangles. For example, the standard setting envisioned uses six depth cameras 1521-1526 with 256×256 resolution. However, the required number of depth cameras and the required resolution of each camera can be further optimized to reduce, and the performance, i.e., image quality and amount of transmission data, will vary depending on the number of depth cameras and their resolution.

As an example, FIG. 15 shows a configuration in which six depth cameras 1521 to 1526 and one normal camera 1530 are arranged. Conventional camera (i.e., an RGB camera) 1530 is used to capture color and alpha information of objects in scene of interest 1510.

Alternative method may be to use only a regular RGB camera without using a depth camera. In this case, the position of the object is estimated from the image acquired by the RGB camera, and the geometry information is created. Note that there is an alternative approach bypassing the concept of the virtual cameras to process the mesh directly. That is bypassing the data capture step, point cloud processing, and tessellation using the tessellated data directly, making use of the graphics engine intrinsic shader to manage the geometry information.

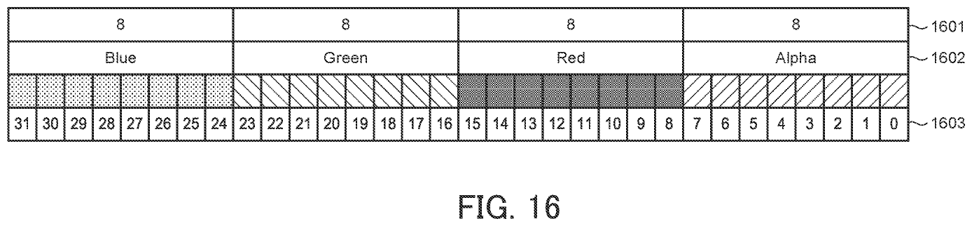

FIG. 16 is a diagram showing a configuration of pixels in an ARGB system used in this disclosure. The ARGB system adds alpha information (A) which represents transparency to the color information of conventional RGB (red, green, blue). In the illustrative example shown in FIG. 16, each of alpha, blue, green, and red is represented by 8 bits (i.e., 256 gray levels), i.e., a 32-bit configuration throughout ARGB. In FIG. 16, reference numeral 1601 denotes the number of bits of each color or alpha, 1602 denotes each color or alpha, and 1603 denotes a configuration of 32 bits as a whole. In this embodiment, a 32-bit ARGB system having 8-bit configurations of colors and alpha as a whole is described, but the number of these bits can be changed in accordance with a desired image quality and a transmission data amount.

Alpha information can be used as a mask/secondary layer for color images. Due to the current hardware encoder restrictions, it is time consuming to encode the video stream for color information with alpha information. Also, software encoders for colors and alpha for video streams cannot be an alternative to this disclosure at present because they cannot be encoded in real time, are delayed, and cannot achieve the objectives of the present disclosure.

### 6.1 Advantages of Reconstruction of the Geometry of a 3D Stream Scene According to This Disclosure

The advantages of geometric reconstruction of 3D streaming scenes using this disclosure methods are as follows. This disclosure approach reconstructs every scene on the client-side by reconstructing the scene using a “cloud of triangles”. An important aspect of this innovative idea is that it is ready to use a large number of triangles on the client side. The number of triangles included in the group of triangles may be hundreds of thousands.

The clients are ready to place their triangles at the appropriate locations to create the shapes of 3D scenes as soon as they obtain information from the streams. Since this disclosure method transfers less data from the server to the clients than before, the advantages of this method are that the power and time required to process the data can be reduced. Rather than the conventional method of generating a mesh per frame, the position of the existing geometry is changed. However, by changing the position of the existing geometry, it is possible to change the position of the group of triangles once generated in the scene. Thus, the geometry data provides the coordinates of each triangle, and this change in position of the object is dynamic.

### 6.2 Advantages of 3D Streaming According to This Disclosure

The advantages of the 3D streaming according to this disclosure are that even six Degree of Freedom are less delayed. One of the advantages of the 3D streaming formats is that there are 3D scenes on the client-side as well. When navigating in mixed reality (MR) or looking around in images, the key part is how 3D contents are connected to the real world, and how “the real position is felt to it”. In other words, if the user is not aware of the delay of the location update by the device as he or she is walking around some displayed objects, the human brain will be illusioned that this object is indeed at that location.

Currently, client-side devices target 70 to 90 FPS (frames per second) and update 3D contents on the display to make the user think this is “real”. Today, it is not possible to provide a full cycle of frame updates on a remote server with a latency of 12 ms or less. In fact, the sensor of the AR-device provides information more than 1,000 FPS. This disclosure approach can then synchronize the 3D content on the client side, as it is already possible with modern devices to synchronize the 3D content on the client side. Therefore, after reconfiguring 3D scene, it is the client's job to process the location of the extended content on the client side, and it is possible to solve any reasonable networking issues (e.g., transmission delays) that do not affect reality.

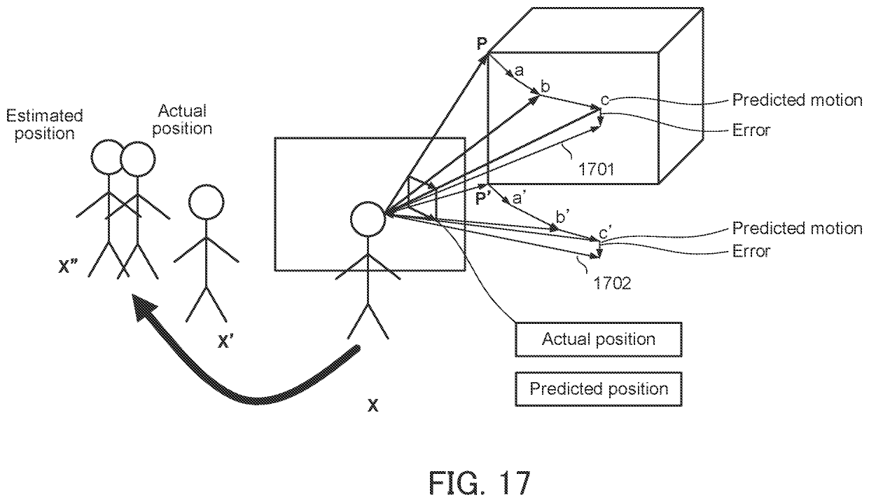

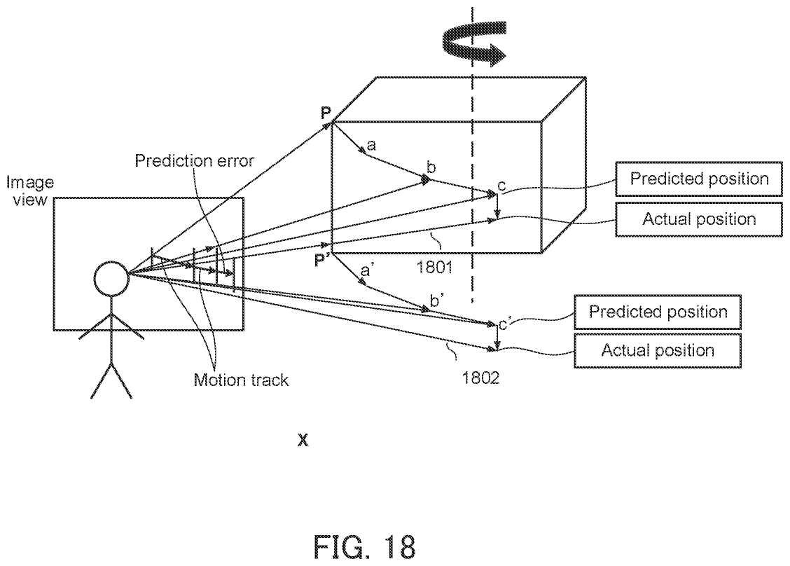

FIG. 17 is a diagram showing change of positon information when the client moved. The motion/position information is received from the client device. The motion of the client is shown in FIG. 17. The motion of the client can be represented as the inverse motion of the target, so we can estimate the position of the target features (FIG. 17 and in more detail in FIG. 18). The pose information is used to build up a history of poses, and thus to predict the motion of the vertex data in the next frame. This updated pose is compared with the next client supplied data set to validate the prediction and, where necessary, correct the estimated motion model. In the figure (see FIG. 17), we see the change in position of the observer (client) leads to a change in the detected position of the vertices. The line PP′, viewed at point X, maps to line aa′ when viewed in position X′ and then maps to bb′ in position X″. The trajectory P-a-b defines a historical trajectory, P(t), where P is the position of a feature at time t. This defines a model of the motion of the vertex. Using this model, we can estimate P(t+1), enabling prediction of points c, c′.

FIG. 18 is a diagram showing motion prediction and error detection in the image view. According to the method shown in FIG. 17 as the client can change direction, therefore the estimate may be subject to error. We then compute the error between P(t+1) and the actual detected position, denoted as the arrows 1801, 1802, leading to the error δP(t) which can be used to update P(t).

The idea is to have FIG. 17 focus on the motion of the client around the target (the cube) and show how the points, in the image plane, are shifted. In FIG. 18, we then show that the same motion is predicted by assuming the motion of the target that is rotating and translating (rather than the observer).

### Summary of the Disclosure

Some examples are appended below as a summary of this disclosure.

A method for sending at least one 3D object from a server to a client, includes: extracting color information, alpha information and geometry information from the 3D object on the server: simplifying the geometry information: and encoding and sending a stream including the color information, the alpha information and the simplified geometry information from the server to the client.

The method according to the disclosure, wherein the simplifying the geometry information is to convert cloud of points extracted from 3D object to information of vertex of triangles.

The method according to the disclosure, wherein the stream further includes at least one of a metadata, a sound data, and a command.

The method according to the disclosure, wherein the server receives a command from the client to redraw the 3D object on the server.

The method according to the disclosure, wherein when the server receives a command from the client to redraw the 3D object, the server redraws the 3D object on the server, extracts the color information, the alpha information and the geometry information from the redrawn 3D object: simplifies the geometry information: and encode and sends a stream including the color information, the alpha information and the simplified geometry information of the redrawn 3D object from the server to the client.

The method according to the disclosure, the color information and the alpha information are captured by an RGB camera and the geometry information is captured by at least one depth camera.

A method for representing a 3D object on a client, includes: receiving from the server, an encoded stream including color information, alpha information and geometry information of the 3D object: decoding the encoded stream and extracting the color information, the alpha information and the geometry information from the stream: reproducing a shape of the 3D object based on the geometry information: and projecting the information combining the color information and the alpha information on the shape of the 3D object to reconstruct the 3D object.

The method according to the disclosure, further including displaying the reconstructed 3D object on a display device.

The method according to the disclosure, the display device is a smart glasses or a headset.

A server includes at least one processor and a memory, the at least one processor by executing instructions store in the memory, to extract color information, alpha information and geometry information from the 3D object on the server: simplify the geometry information: and encode and send a stream including the color information, the color information, the alpha information and the simplified geometry information from the server to a client.

A client includes at least one processor and a memory, the at least one processor by executing instructions stored in the memory, to receive from the server, an encoded stream including color information, alpha information and geometry information of the 3D object: decode the encoded stream and extract the color information, the alpha information and the geometry information from the stream: reproduce a shape of the 3D object based on the geometry information: and project the information combining the color information and the alpha information on the shape of the 3D object to reconstruct the 3D object.

A computer program includes instructions by a processor to execute the method according to the disclosure.

A method for sending at least one 3D object generated based on a position information of a client from a server to the client, comprising: extracting color information, alpha information and geometry information from the 3D object on the server: simplifying the geometry information: and encoding a stream including the color information, the alpha information and the simplified geometry information and sending the encoded stream from the server to the client.

The method according to the disclosure, wherein the simplifying the geometry information is to remove high frequency component from the geometry information.

The method according to the disclosure, wherein the stream further includes at least one of position information of the client, metadata, sound data, and a command.

The method according to the disclosure, wherein the server receives a command from the client to redraw the 3D object on the server and the command includes a position information of the client.

The method according to the disclosure, wherein when the server receives a command from the client to redraw the 3D object, the server redraws the 3D object on the server based on a position information of the client included in the command, extracts the color information, the alpha information and the geometry information from the redrawn 3D object, simplifies the geometry information, and encodes a stream including the color information, the alpha information and the simplified geometry information of the redrawn 3D object and sends the encoded stream from the server to the client.

The method according to the disclosure, the color information, the alpha information, and the geometry information are generated based on an image obtained by an RGB camera.

A method for reproducing a 3D object generated based on a position information of a client on the client, the 3D object being present on a server, the method comprising: receiving from the server, an encoded stream including color information, alpha information and geometry information of the 3D object: decoding the encoded stream and extracting the color information, the alpha information and the geometry information from the decoded stream: reproducing a shape of the 3D object based on the geometry information; and projecting information on the reproduced shape of the 3D object to reconstruct the 3D object, the information resulting from combining the color information and the alpha information.

The method according to the disclosure, further including displaying the reconstructed 3D object on a display device.

The method according to the disclosure, wherein the display device is a smart glass or smart glasses.

A server comprising at least one processor and a memory, wherein the at least one processor executes instructions stored in the memory, to extract color information, alpha information and geometry information from a 3D object generated based on a position information of a client on the server: simplify the geometry information; and encode a stream including the color information, the color information, the alpha information and the simplified geometry information and send the encoded stream from the server to a client.

A client comprising at least one processor and a memory, wherein the at least one processor executes instructions stored in the memory, to receive from a server, an encoded stream n including color information, alpha information and geometry information of a 3D object generated on a position information of the client: decode the encoded stream and extract the color information, the alpha information and the geometry information from the decoded stream; reproduce a shape of the 3D object based on the geometry information; and project information on the reproduced shape of the 3D object to reconstruct the 3D object, the information resulting from combining the color information and the alpha information.

A computer program including instructions for a processor to execute the method according to the disclosure.

This disclosure may be implemented in software, hardware, or software in conjunction with hardware.

This application is entitled to and claims the benefit of Japanese Patent Application No. 2021-037507 filed on Mar. 9, 2021, the disclosure of which including the specifications, drawings and abstracts are incorporated herein by reference in their entirely.

### INDUSTRIAL APPLICABILITY

The present disclosure is applicable to software, programs, systems, devices, client-server systems, terminals, and the like.

### REFERENCE SIGNS LIST

100 Server

101 Received Data Processing Unit

102 3D scene data creation unit

103 Extraction unit

104 3D Stream Conversion/Encoding Unit

105 3D Stream

106 Network packet construction unit

107 Network packet transmission unit

108 Network packet reception unit

120 Wired or wireless network

150 Client

150-1 Client

150-2 Client

151 Network packet transmission unit

152 Network packet reception unit

153 Application data output unit

154 3D stream decoding unit

155 3D scene reconstruction unit

156 Display unit

601 CPU/GPU

602 Display unit

603 Input/output unit

604 Memory

605 Networking interface

606 Storage unit

607 Bus

603 Input/output unit

704 Memory

705 Networking interface

706 Storage unit

707 Bus

1201 Screen

1202 Person

1203 Container stream

1210 Smart glasses

1211-1 Person

1211-2 People

1212-1 Cursor

1212-2 Cursor

1213 Command

1214 Person

1221 Terminal device

1521 to 1526 Depth camera

1530 RGB camera

1. A method for sending at least one 3D object generated based on a position information of a client from a server to the client, comprising:
extracting color information, alpha information and geometry information from the 3D object on the server;
simplifying the geometry information; and
encoding a stream including the color information, the alpha information and the simplified geometry information and sending the encoded stream from the server to the client.

2. The method according to claim 1, wherein the simplifying the geometry information is to remove high frequency component from the geometry information.

3. The method according to claim 1, wherein the stream further includes at least one of position information of the client, metadata, sound data, and a command.

4. The method according to claim 1, wherein the server receives a command from the client to redraw the 3D object on the server and the command includes a position information of the client.

5. The method according to claim 1, wherein when the server receives a command from the client to redraw the 3D object, the server redraws the 3D object on the server based on a position information of the client included in the command, extracts the color information, the alpha information and the geometry information from the redrawn 3D object, simplifies the geometry information, and encodes a stream including the color information, the alpha information and the simplified geometry information of the redrawn 3D object and sends the encoded stream from the server to the client.

6. The method according to claim 1, the color information, the alpha information, and the geometry information are generated based on an image obtained by an RGB camera.

7. A method for reproducing a 3D object generated based on a position information of a client on the client, the 3D object being present on a server, the method comprising:
receiving from the server, an encoded stream including color information, alpha information and geometry information of the 3D object;
decoding the encoded stream and extracting the color information, the alpha information and the geometry information from the decoded stream;
reproducing a shape of the 3D object based on the geometry information; and
projecting information on the reproduced shape of the 3D object to reconstruct the 3D object, the information resulting from combining the color information and the alpha information.

8. The method according to claim 7, further including displaying the reconstructed 3D object on a display device.

9. The method according to claim 8, wherein the display device is a smart glass or smart glasses.

10. A server comprising at least one processor and a memory, wherein
the at least one processor executes instructions stored in the memory, to
extract color information, alpha information and geometry information from a 3D object generated based on a position information of a client on the server;
simplify the geometry information; and
encode a stream including the color information, the color information, the alpha information and the simplified geometry information and send the encoded stream from the server to a client.

11. A client comprising at least one processor and a memory, wherein
the at least one processor executes instructions stored in the memory, to
receive from a server, an encoded stream including color information, alpha information and geometry information of a 3D object generated on a position information of the client;
decode the encoded stream and extract the color information, the alpha information and the geometry information from the decoded stream;
reproduce a shape of the 3D object based on the geometry information; and
project information on the reproduced shape of the 3D object to reconstruct the 3D object, the information resulting from combining the color information and the alpha information.

12. A computer program non-transitory computer-readable recording medium including instructions for a processor to execute the method according to claim 1.

13. A non-transitory computer-readable recording medium including instructions for a processor to execute the method according to claim 7.
